(19) United States
(12) Patent Application Publication
(10) Pub. No.: US 2014/0356495 A1
(43) Pub. Date: Dec. 4, 2014

(54) Apparatus Having Motion Reset Functionality, and Systems and Methods for Timing the Cooking of Food

(71) Applicant: Daniel Teuscher, Arlington Heights, IL (US)

(72) Inventor: Daniel Teuscher, Arlington Heights, IL (US)

(21) Appl. No.: 14/294,398

(22) Filed: Jun. 3, 2014

Related U.S. Application Data
(60) Provisional application No. 61/830,938, filed on Jun. 4, 2013.

(51) Int. Cl. G04F 3/06; A21B 3/00; A23L 1/01; A47J 37/06

(52) U.S. Cl. CPC G04F 3/06; A47J 37/06; A21B 3/00; A23L 1/0128
USPC 426/231; 99/342; 368/106; 368/10

(57) ABSTRACT

The present invention relates to a timing device for cooking, namely grilling, baking, convection, and other methods known to one skill in the art. Specifically, the present invention relates to a timing device that, in a preferred embodiment of the present invention, provides the amount of time food has been cooking and the amount of time since the last time the food was checked. Specifically, the present invention preferably resets a timer when a cooking device, such as a grill or an oven, is opened and/or closed. More specifically, the present invention provides one timer that resets when a cooking device is opened and/or closed and optionally at least one other timer that remains running. The timers can be stopped, started, turned on and off, and reset manually.

The present invention claims priority to U.S. Provisional Patent Application No. 61/830,938 entitled “Apparatus Having Motion Reset Functionality, And Systems And Methods For Timing The Cooking Of Food,” filed Jun. 4, 2013, which is incorporated herein by reference in its entirety.

### TECHNICAL FIELD

The present invention relates to a timing device for cooking, namely grilling, baking, convection, and other methods known to one skill in the art. Specifically, the present invention relates to a timing device that, in a preferred embodiment of the present invention, provides the amount of time food has been cooking and the amount of time since the last time the food was checked. Specifically, the present invention preferably resets a timer when a cooking device, such as a grill or an oven, is opened and/or closed. More specifically, the present invention provides one timer that resets when a cooking device is opened and/or closed and optionally at least one other timer that remains running. The timers can be stopped, started, turned on and off, and reset manually.

### BACKGROUND

It is, of course, generally known to cook food in cooking devices such as a microwave, a stove, an oven, a grill, or other alternative cooking device known to one skilled in the art. Regardless of which method is used to cook food, the time food is being cooked is extremely important. Cooking food for too long can lead to burnt, dry, hard, or otherwise unsavory side effects. Undercooking food can lead to unsavory foods, discomfort or foodborne illnesses.

It is also generally known to prefer food to be cooked to different temperatures and over different times. Meats, for example, can be cooked blue, rare, medium-rare, medium, medium-well, well-done, or overcooked. Blue meats are cooked very quickly achieving a temperature between 115° F.-120° F. Rare meats are cooked to about 125° F.-130° F. Medium-rare meats are cooked to about 130° F.-140° F. Medium meats are cooked to about 140° F.-150° F. Medium-well meats are cooked to about 150° F.-155° F. Well-done meats are cooked to about 160° F.-212° F. and overcooked meats may be cooked above 212° F. Of course, standards for the temperature of meat may fluctuate from person to person.

Normally, it takes different times to cook different foods. It also takes different times to cook those foods to different temperatures. Commonly, people time how long food has been cooking in order to thoroughly cook the food. One can set a timer and when the timer goes off, the food will be cooked. When preparing multiple foods to multiple temperatures, a single timer becomes difficult to use.

Sometimes, people refrain from using a timer for cooking foods. This may be because they do not have a timer or the timer isn't near the cooking device. Frequently, timing devices are not placed near cooking devices in order to prevent damage to the timing device. Timing devices placed near cooking devices may be exposed to weather, extreme heat, and vibrations from opening and closing the cooking device.

Frequently, the time it takes to thoroughly cook food fluctuates. One may check on his or her food and find that the food is cooking faster or slower than previously anticipated. Generally, people check their food by opening an oven, grill, or other cooking device. This allows heat contained in the cooking device to leave the cooking device and may also fluctuate the time needed to thoroughly cook the food.

Commonly, one must adjust the length of time the food is being cooked accordingly to thoroughly cook the food. Adjusting a timer can become time consuming, annoying, and confusing. Further, changing a timer during cooking deviates from a structured cooking time; the cooking time becomes more speculative.

In fact, it is generally known to estimate cooking time instead of using a timer. Frequently, many people forget how long food has been cooking or how long it has been since the food was last checked.

Of course, it is also generally known to set or reset timers. Generally, one interacts with a timer physically in order to set or reset the timer. Often this physical interaction step discourages people from setting, resetting, or using a timer in general.

Moreover, it is generally known to use movement of a switch as a triggering mechanism. Mercury switches involve a small amount of liquid mercury sealed with two contact points. When the mercury is rotated to contact both contact points, a circuit is completed. Other conducting metals may be used alternatively, including solid metal, such that the two contact points can conduct a current through the solid metal. Other similar modern switches include accelerometers, level sensors, motion detectors, vibration detectors, and gyroscopes.

A need, therefore, exists for an apparatus for timing the cooking of food, especially when a user forgets to set a timer. Specifically, a need exists for an apparatus that times the total length of time cooked. A need also exists for an apparatus that counts the length of time since the food was last checked.

Moreover, a need exists for a trigger that recognizes the movement associated with a cooking device, such as the opening or closing of a grill lid or an oven lid. Additionally, a need exists for an apparatus that resets a timer every time a cooking device, a cooking utensil, or alternative cooking apparatus is moved.

Also, a need exists for an apparatus that can be attached to the handle of a cooking device. Alternatively, a need exists for an application that can wirelessly detect when a cooking device is moved, opened, orclosed.

Additionally, a need exists for an apparatus that can be used at night or day. Furthermore, a need exists for an apparatus that can be manually reset, stopped, started, turned off, and turned on. Lastly, a need exists for an apparatus that is resistant to weather, heat, and vibrations.

### SUMMARY OF THE INVENTION

The present invention relates to a timing device for cooking, namely grilling, baking, convection, and other methods known to one skill in the art. Specifically, the present invention relates to a timing device that, in a preferred embodiment of the present invention, provides the amount of time food has been cooking and the amount of time since the last time the food was checked. Specifically, the present invention preferably resets a timer when a cooking device, such as a grill or an oven, is opened and/or closed. More specifically, the present invention provides one timer that resets when a cooking device is opened and/or closed and optionally at least one other timer that remains running. The timers can be stopped, started, turned on and off, and reset manually.

To this end, in an embodiment of the present invention, a timing apparatus is provided. The timing apparatus, having a first end, a second end, and a length between the first end and the second end, comprises a first timer on the first end, at least one additional timer on the first end, a switch that resets the first timer upon receiving a signal, wherein the signal is conveyed from a cooking device, and at least one interaction device on the second end.

Moreover, in an alternate embodiment of the present invention, a timing system is provided. The timing system comprises a timing apparatus, having a first end, a second end, and a length between the first end and the second end, comprising a first timer on the first end, at least one additional timer on the first end, a switch that resets the first timer upon receiving a signal, and at least one interaction device on the second end; and a cooking device, the cooking device having a door wherein the signal is conveyed from the cooking device when the door is closed.

Further, in an alternate embodiment of the present invention, a timing method is provided. The timing method comprises providing a timing apparatus, having a first end, a second end, and a length between the first end and the second end, comprises a first timer on the first end, at least one additional timer on the first end, a switch that resets the first timer upon receiving a signal, and at least one interaction device on the second end; providing a cooking device, wherein the cooking device has a door that conveys the signal when the door is closed; opening the door of the cooking device; and closing the door of the cooking device, wherein the cooking device conveys the signal to the switch.

It is, therefore, an advantage of the present invention to provide an apparatus for timing the cooking of food, especially when a user forgets to set a timer.

Specifically, it is an advantage of the present invention to provide an apparatus that times the total length of time cooked and the length of time since it was last checked.

Moreover, it is an advantage of the present invention to provide a trigger that recognizes the moving, opening, or closing of a cooking device.

Additionally, it is an advantage of the present invention to provide an apparatus that resets a timer every time a cooking device is moved, opened, or closed.

Also, it is an advantage of the present invention to provide an apparatus that can be attached to the handle of a cooking device.

Further, it is an advantage of the present invention to provide an application that can wirelessly detect when a cooking device is move, opened, or closed.

Additionally, it is an advantage of the present invention to provide an apparatus that can be used at night or day.

Furthermore, it is an advantage of the present invention to provide an apparatus that can be manually reset, stopped, started, turned off, and turned on.

Lastly, it is an advantage of the present invention to provide an apparatus that is resistant to weather, heat, and vibrations.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a front view of a timing apparatus in a preferred embodiment of the present invention.

FIG. 2 illustrates a side view of a timing apparatus attached to a handle in an embodiment of the present invention.

FIG. 3 illustrates a rubber strap used to attach a timing apparatus to a handle in an embodiment of the present invention.

FIG. 4A illustrates a perspective view of a timing apparatus attached to a cooking device in an embodiment of the present invention.

FIG. 4B illustrates a perspective view of a timing apparatus disposed within a cooking device in an embodiment of the present invention.

FIG. 5A illustrates a side view of a timing apparatus attached to a cooking utensil in an embodiment of the present invention.

FIG. 5B illustrates a side view of a timing apparatus disposed within a cooking utensil in an embodiment of the present invention.

### DETAILED DESCRIPTION OF THE PRESENTLY PREFERRED EMBODIMENTS

The present invention relates to a timing device for cooking, namely grilling, baking, convection, and other methods known to one skill in the art. Specifically, the present invention relates to a timing device that, in a preferred embodiment of the present invention, provides the amount of time food has been cooking and the amount of time since the last time the food was checked. Specifically, the present invention preferably resets a timer when a cooking device, such as a grill or an oven, is opened and/or closed. More specifically, the present invention provides one timer that resets when a cooking device is opened and/or closed and optionally at least one other timer that remains running. The timers can be stopped, started, turned on and off, and reset manually.

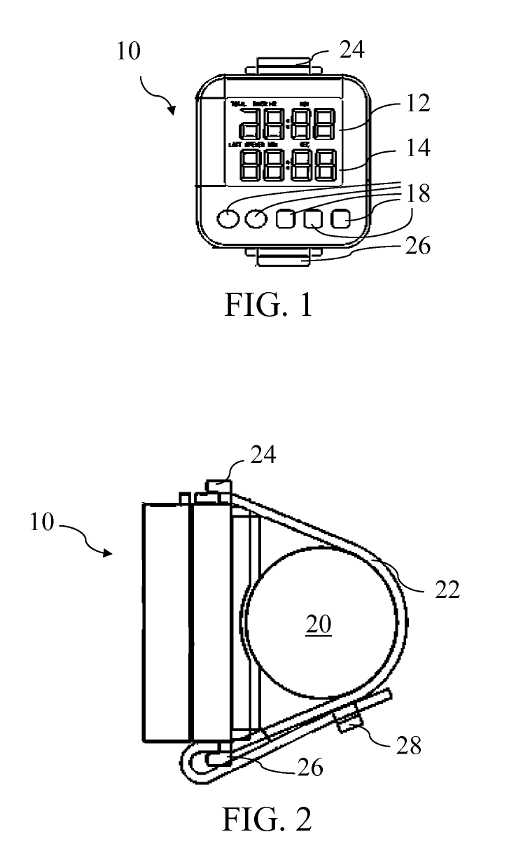

Now referring to the figures, wherein like numerals refer to like parts, FIG. 1 illustrates a timer apparatus 10. The timer apparatus 10 may be square as shown in FIG. 1, but may be of any shape known to one skilled in the art. The timer apparatus 10 may comprise one or a plurality of timers 12, wherein at least one of the plurality of timers 12 may be a check timer 14. The plurality of timers 12 may be analog or digital time displays. The timer apparatus 10 may have a check timer 14 that may, in a normal operation, count upwards from a base time, such as zero, and that may be reset upon movement of the timer apparatus 10 itself. Thus, the timer apparatus 10 may detect movements to itself, and reset the check timer 14 to the base time. Upon ceasing movement, the check timer 14 may resume counting up from the base time.

In an alternative embodiment, the check timer 14 may stop counting when initially moved, such as when a grill cover or oven door opens, thereby freezing the time so that the same may be checked by a user thereof. Subsequently, the check timer 14 may reset and commence counting up from the base time, which may be zero, when movement ceases, or when a cooking device cover or lid is closed.

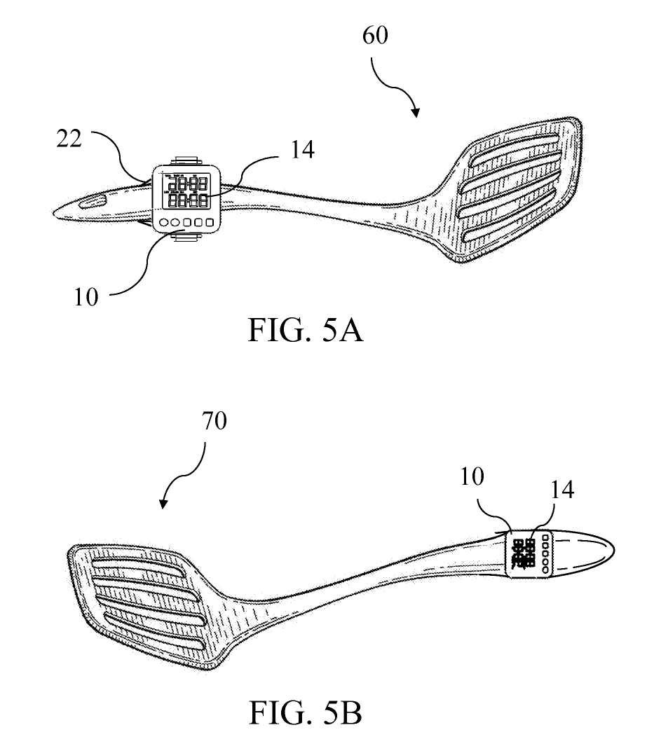

In an exemplary embodiment, the timer apparatus 10 may be attached to a cooking device (not shown), and the check timer 14 may display how long from when the cooking device has last been moved. Preferably, the cooking device may be an oven, grill, stove, or the like, but may also be an auxiliary device such as a cooking utensil or accessory. For example, the cooking device may be a spatula and may have the check timer 14 incorporated thereon as further shown in FIG. 5B. In another example, the cooking device may be an accessory such as a grill or oven light, and may have the check timer 14 incorporated thereon.

In a preferred embodiment, the check timer 14 may display how long from the last time a grill or oven lid, for example, closed. For example, the check timer 14 may reset or freeze after a user opens the cooking device, checks on a food item inside the cooking device, and may start counting from the base time, which may be zero, again when the user closes the cooking device. The check timer 14 may continue to count until the next time the food item is checked by opening and subsequently closing the cooking device.

The plurality of timers 12 may display alternate times such as the total time the food item has been cooking, a countdown from a predetermined quantity of time, the time of day, or other relevant time function known to one skilled in the art. In an embodiment, the timer apparatus 10 may only have the check timer 14 and no other timers associated therewith. In this embodiment, the total time the food item has been cooking may still be implemented when the check timer 14 is never reset, which would otherwise happen when the check timer 14 is moved. In other words, if the check timer 14 does not move to reset, the check timer 14 may therefore count the total time the food item has been cooking. In an alternate embodiment, the timing apparatus may have at least two timers: a check timer 14, and a second timer for providing a different time measurement, such as the total elapsed time since it was reset, without having the capability of being reset upon movement of the same. Thus, elapsed time since last moved, and the total elapsed time may be displayed.

Inside of the timer apparatus 10 may be a switch. The switch may be hardware or software and may reset the check timer 14 when the cooking device is moved. For example, the switch may reset when a grill lid, or an oven door, or some other component of a cooking device, is moved. In a preferred embodiment, the switch may trigger when a grill lid or an oven door, for example, is opened, resetting the interconnected timer, and may start again from the base time, which may be zero, when the grill lid or over door is closed. Specifically, the switch may reset the timer if a door of the cooking device is opened a certain amount or by a specific degree. In an exemplary embodiment, the cooking device door may be required to open at least 30°. The switch may not reset the check timer 14 if the cooking device is merely shifted or the cooking device door is minimally moved.

The switch may reset the check timer 14 when the switch receives a reset signal from the cooking device indicating that the cooking device has been opened and/or shut. The reset signal may be conveyed directly when the timer apparatus 10 is attached or part of the cooking device. The reset signal may also be conveyed wirelessly through Bluetooth, WI-FI, radio waves, or other wireless communication known to one skilled in the art. Of course, the reset signal may be conveyed through an alternate method of communication known to one skilled in the art.

The timer apparatus 10 may further comprise a plurality of interaction devices 18. The interaction devices 18 may be, for example, buttons that may be used to manually stop, start, lap, reset, set an alarm, add a minute, remove a minute, turn the timer apparatus 10 on, turn the timer apparatus 10 off, and/or similar function known to one skilled in the art.

As shown in FIG. 2, the timer apparatus 10 may be attached to the cooking device via a handle 20. The timer apparatus 10 may be attached by applying a strap 22 to a first hook 24, around the handle 20, and to a second hook 26. The strap 22 may have a loop 28 that may hold any excess length of strap 22 not needed to attach the timer apparatus 10 to the handle 20. The back of the timer apparatus 10 may be arcuate to closely fit against the handle 20. Of course, the back of the timer apparatus 10 may be of any shape known to one skilled in the art such that it fits closely against the handle 20.

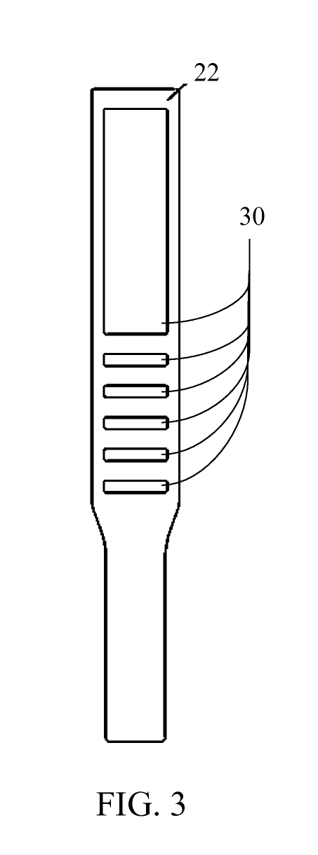

As shown in FIG. 3, the strap 22 may have a plurality of openings 30. The plurality of openings 30 may be used around the first hook 24 and the second hook 26 shown in FIGS. 1-2. The strap 22 may be Velcro®, rubber, plastic, or other material known to one skilled in the art. The strap 22 may be wrapped around the handle 20 and any excess length of strap 22 may be placed within one of the plurality of openings 30 not being used.

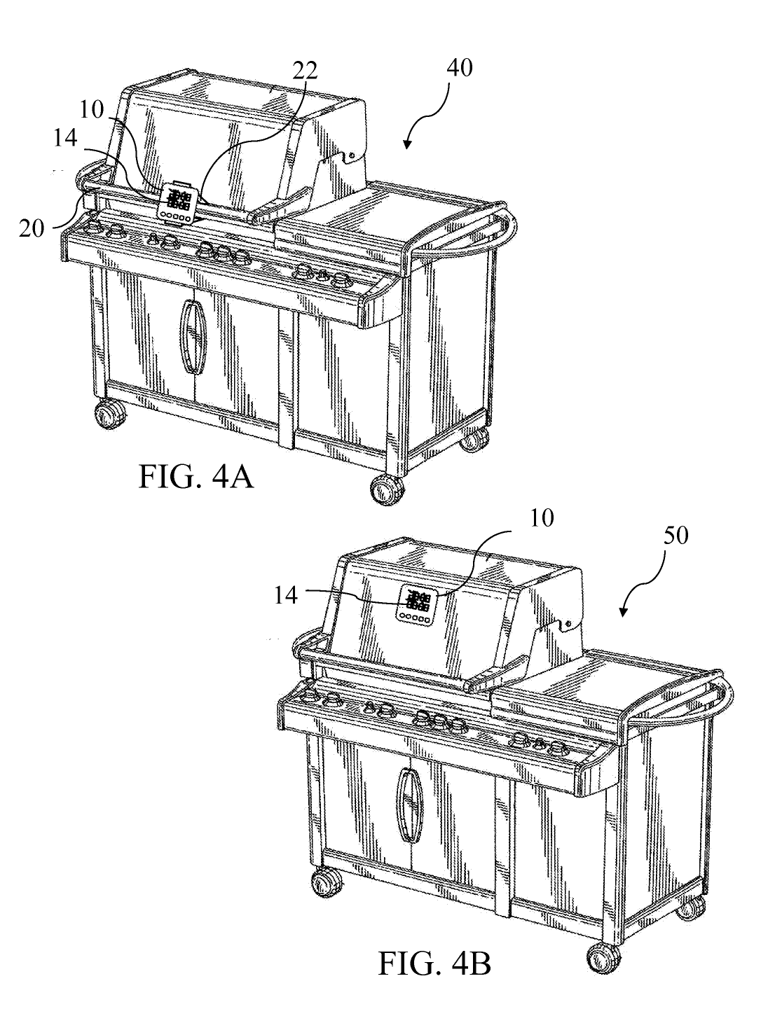

In an embodiment, a grill 40 is shown as the previously mentioned cooking device in FIG. 4A. Of course, any cooking device, such as an oven, microwave, toaster, broiler, or other cooking device known to one skilled in the art, may be used with the present invention and the grill 40 is shown merely for demonstrative purposes. Like in FIG. 2, the timer apparatus 10 may be wrapped around the handle 20 of the grill 40 via the strap 22. Therefore, the timer apparatus 10 may be added to existing cooking devices such as the grill 40. Alternatively, the timer apparatus 10 may be built into a grill 50, as shown in FIG. 4B. In this embodiment, the timer apparatus 10 may similarly function as described herein, but may be integrally contained on or within the grill 50. This may eliminate the need for supplemental components and may provide an aesthetic appearance.

In one embodiment, the timer apparatus 10 may create the reset signal. The timer apparatus 10 may comprise a sensor that determines when the cooking device door is closed by determining changes in rotation, height, length, acceleration, deceleration, velocity, or like motion known to one skilled in the art. The sensor may be an accelerometer, a level sensor, a gyroscope, a motion detector, a vibration detector, or similar sensor known to one skilled in the art. The sensor may determine when the cooking device door is opened and closed and subsequently create a signal to convey to the switch.

In an alternate embodiment, the switch may double as the sensor when a tilt switch is used, such as, for example, a mercury switch or other like switch. For example, a tilt switch may be placed horizontally within the timer apparatus 10 such that the contacts within the tilt switch do not touch the conducting metal. The tilt switch may be connected to a power source on one end and to the check timer 14 on another end. The timer apparatus 10 may then be moved along with the door of the cooking device. The door of the cooking device and the timer apparatus 10 may be rotated and the tilt switch may consequently rotate and cause the conducting metal to touch the contacts within the tilt switch. The power source may then be connected to the check timer 14. The check timer 14 may reset upon being connected to the power source. When closed, the door of the cooking device and the timer apparatus 10 may be rotated back, and may effectively remove the conducting metal from the contacts within the tilt switch. The power source may be disconnected from the check timer 14 and the check timer 14 may thus proceed to measure the amount of time until the next time the tilt switch is rotated. Of course, the tilt switch may be set in any number of positions known to one skilled in the art such that closing the cooking device door conveys a reset to the check timer 14.

In an alternate embodiment, a pair of contacts may be used to create the reset signal. For example, a pair of contacts may be implemented in the cooking device door. When the cooking device door is shut, the contacts may interact and complete a circuit that sends the reset signal. The circuit may be as simple as a power source, the pair of contacts, an inverter logic gate, resistance, and ground. The circuit may also include wireless communication as mentioned above. When the contacts interact, the power source may be connected to the inverter and send a low value or logic “0.” As mentioned above, the logic signal may be sent by wire or wirelessly. The logic “0” may tell the switch to do nothing and allow check timer 14 to count freely. When the contacts are separated, such as when the cooking device door is opened, the circuit may be broken and the power source disconnected from the inverter. A high value or logic “1” may then be sent to the switch, telling the switch to reset the check timer 14. The switch may receive a logic “1” the entire time the cooking device is open and continuously reset the check timer 14 until the cooking device is closed. Upon closing the device, the switch may receive a logic “0” and allow the check timer 14 to count, thereby timing how long the cooking device door has been shut. Of course, this circuit is merely an example and an alternate circuit known to one skilled in the art may be implemented to perform the functions of the present invention. For example, a laser may be implemented that conveys a reset signal when the laser beam is broken by closing the cooking device door.

The timer apparatus 10 may be a standalone device or may be implemented in an application for mobile devices. For example, modern smart phones have accelerometers and timing capabilities already provided within. The present invention may be implemented as an application that takes advantage of those capabilities. The mobile device may be able to receive a wireless signal sent from the cooking device or may be otherwise attached to the cooking device as described above.

Of course, an accelerometer, a level sensor, a motion detector, a vibration detector, a gyroscope, a tilt switch may be connected to a wireless communication device and implemented within the cooking device instead of the timer apparatus 10. Upon closing the cooking device door, the accelerometer, level sensor, motion detector, vibration detector, gyroscope, tilt switch, or other device known to one skilled in the art may convey a reset signal wirelessly to the timer apparatus 10. The timer apparatus 10 may count as described above until receiving said reset signal from the cooking device.

The timer apparatus 10 may further comprise a light and a backlight. The light may be used to shine into the cooking device so that the food inside the cooking device may be seen. The backlight may be used to display the plurality of timers 12 in the dark. Preferably, the timer apparatus 10 may be weather, heat, cold, vibration, and damage resistant.

It should be noted that the present invention may be a stand-alone apparatus that may be attached to a cooking device, such as shown in FIGS. 1 and 2. However, it should also be noted that the present invention may be integrally attached or otherwise interconnected to a cooking device, such as the grill 50 shown in FIG. 4B and a spatula 70 further shown in FIG. 5B, and may not be removable as described herein.

Moreover, the timer apparatus 10 of the present invention may be able to withstand weathering and extreme temperatures. For example, it is typical for a grill to be left outside, and the timer apparatus 10 may preferably be able to withstand cold, heat, sun, rain, or other weather phenomena. In addition, in a preferred embodiment, the timer apparatus 10 may be interconnected to a grill cover, an over door, or other like cooking device door that may become very hot due to the heating of the cooking devices. Thus, the timer apparatus 10 may be reinforced with heatshielding to ensure that the timer apparatus 10 is able to withstand the same.

In another embodiment of the present invention, the timer apparatus 10 may be incorporated into another object, such as a cooking utensil, that may be utilized during the cooking of food. In many cases, spatulas, spoons, tongs, or other like cooking utensils, are picked up by a user and utilized when the user checks on food, such as meat or other foods on a grill, on a stove, or in an oven. Thus, utilization of the cooking utensil may provide an indication of when foods are checked at a cooking device.

In one embodiment of the present invention, a user may utilize a spatula for cooking food on a grill, oven, or other cooking device. A spatula 60, as shown in FIG. 5A, may have the timer apparatus 10 wrapped therearound with the strap 22. The timer apparatus 10 may be attached around the spatula 60 much like the timer apparatus 10 attaches to the grill 40 in FIG. 4A. Of course, the timer apparatus may be attached around any number of items without departing from the scope of the present invention. The timer apparatus 10 may be the same size whether the timer apparatus 10 is attached to the grill 40 or the spatula 60. However, the timer apparatus 10 may come in any number of sizes to better fit a variety of cooking devices and/or accessories. The spatula 70, as shown in FIG. 5B, may alternatively include the timer apparatus 10 in the handle thereof In these embodiments, the check timer 14 on the timer apparatus 10 may reset when the spatula 60, 70 is moved, which may typically occur when a user picks up the spatula 60, 70 to check on the food on the grill, oven, or other cooking device. Upon placement of the spatula 60, 70 back down, the check timer 14 may start counting up from the base time, which may be zero, thereby providing a display of the amount of time from the last time the spatula 60, 70 was moved.

Again, as described above, the timer apparatus 10 may include other timer displays measuring the passage of time in other ways, such as total elapsed time, the real time, a timer that counts down to an alarm, or any other timer display and functionality apparent to one of ordinary skill in the art.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A cook timer apparatus, the cook timer apparatus comprising:
a housing comprising a first timer having a first timer display, wherein the first timer counts upwards from a base time and the first timer display shows the elapsed time from the base time; and
a switch that resets the first timer when the cook timer apparatus is moved, wherein the first timer display resets to the base time when the first timer resets.

2. The cook timer apparatus of claim 1 further comprising a back of the housing capable of fitting closely against a handle of a cooking device.

3. The cook timer apparatus of claim 1 further comprising at least one interaction device on the housing, wherein the at least one interaction device is a button selected from the group consisting of a start button, stop button, lap button, reset button, alarm set button, add a minute button, remove a minute button, on button, and off button.

4. The cook timer apparatus of claim 1 wherein the switch is selected from the group comprising of an accelerometer, a level sensor, a motion detector, a vibration detector, a gyroscope, a tilt switch, and combinations thereof.

5. The cook timer apparatus of claim 1 wherein the cook timer apparatus is integrated within a cooking device, further comprising:
a first contact point disposed on a door of the cooking device; and
a second contact point disposed on the inside of the cooking device;
wherein the first contact point and the second contact point are electrically connected to the switch and further wherein the first contact point and the second contact point reset the switch when the first contact point contacts the second contact point.

6. The cook timer apparatus of claim 1 further comprising a wireless communication module electrically connected to the switch.

7. The cook timer apparatus of claim 1 wherein the cook timer apparatus is integrated within a cooking utensil.

8. A cook timer system, the cook timer system comprising:
a cooking device, wherein the cooking device has a movable component; and
a cook timer apparatus comprising a housing, a first timer, a first timer display on the housing, and a signal receiving mechanism associated with the first timer that resets the first timer upon receiving a reset signal, wherein the signal is received by the signal receiving mechanism when the moveable component is moved.

9. The cook timer system of claim 8 further comprising at least one interaction device on the housing of the cook time apparatus, wherein the at least one interaction device is a button selected from the group consisting of a start button, stop button, lap button, reset button, an alarm set button, an add a minute button, a remove a minute button, an on button, and an off button.

10. The cook timer system of claim 8 further comprising a switch for sending a signal to the signal receiving means, wherein the switch is selected from the group comprising of an accelerometer, a level sensor, a motion detector, a vibration detector, a gyroscope, and a tilt switch.

11. The cook timer system of claim 8 further comprising:
a first contact point disposed on the moveable component of the cooking device; and
a second contact point disposed on the inside of the cooking device;
wherein the first contact point and the second contact point are electrically connected to a signal generator and further wherein the first contact point and the second contact point generate the reset signal when the first contact point contacts the second contact point.

12. The cook timer system of claim 8 wherein the cooking device and the cook timer apparatus further comprise a wireless communication module.

13. The cook timer system of claim 8 further comprising:
a first contact point disposed on the moveable component of the cooking device; and
a second contact point disposed on the inside of the cooking device;
wherein the first contact point and the second contact point are electrically connected to a signal generator and further wherein the first contact point and the second contact point generate the reset signal when the first contact point is removed from contact with the second contact point.

14. The cook timer system of claim 8 further comprising a strap on the housing disposed around a handle of the cooking device.

15. A method for timing the cooking of food, the method comprising the steps of:
providing a cooking device, wherein the cooking device has a movable component;
providing a cook timer apparatus having a housing and further comprising a first timer and a switch that resets the first timer when the cook timer apparatus is moved, the cook timer apparatus associated with the movable component of the cooking device;
moving the movable component of the cooking device, wherein moving the movable component causes the cook timer apparatus to move, and movement of the cooking device resets the timer.

16. The method of claim 15 wherein a signal is sent to from the switch to the first timer when the movable component of the cooking device is moved.

17. The method of claim 15 wherein the cooking device is a grill and the movable device is a grill lid, further comprising the step of:
opening the lid of the grill, wherein opening the lid of the grill causes the first timer to reset.

18. The method of claim 15 further comprising the step of:
attaching the cook timer apparatus to the movable component of the cooking device.

19. The cook timer method of claim 15 wherein the cook timer apparatus further comprises a second timer, the method further comprising the step of:
starting the first timer and the second timer when a user begins to cook.

20. The cook timer method of claim 19 further comprising the steps of:
moving the movable device, wherein moving the movable device resets the first timer, further wherein the second timer continuously counts without resetting when the movable device is moved.
